(19) United States
(12) Patent Application Publication
(10) Pub. No.: US 2012/0330736 A1
(43) Pub. Date: Dec. 27, 2012

(54) System and Method of Gifting, Gift Sharing, and Gift Redemption

(76) Inventors: Sean Beckner, Overland Park, KS (US); Matthew Beckner, Lenexa, KS (US)

(21) Appl. No.: 13/485,440

(22) Filed: May 31, 2012

Related U.S. Application Data
(60) Provisional application No. 61/491,769, filed on May 31, 2011.

(51) Int. Cl. G06Q 30/00

(52) U.S. Cl. 705/14.16

(57) ABSTRACT

A system configured to promote goods and/or services from a business to a user via a network and an interface device of the user. The system provides a method to offer a gift from the business to the user, allow the user to transfer or share the gift with another user, and allow the user to redeem the gift at the business. The system also provides a method to obtain and transmit information related to the user to the merchant.

### CROSS-REFERENCE TO RELATED APPLICATION

This Patent Application claims the benefit and priority of U.S. Provisional Patent Application Ser. No. 61/491,769 filed May 31, 2011, titled “System And Method of Gifting, Gift Sharing, and Gift Redemption,” the entire contents of which is herein incorporated by reference in its entirety.

### BACKGROUND

1. Field

The present general inventive concept relates to a system configured to promote business goods and services to a user via an interface device of the user, and more specifically to a system operable to offer a gift from the business to the user, allow the user to transfer or share the gift with another user, and allow the user to redeem the gift at the business.

2. Related Art

Goods and services are typically purchased from a vendor or merchant by a consumer or customer without any negotiation regarding the terms of a sale or purchase. Merchants typically control the process by determining what goods or services will be offered for sale, when the goods or services will be offered for sale, and the non-negotiable fixed price at which the goods or services will be sold.

Discounts are an integral part of retailing strategies for many goods and services. Merchants rely upon discounts for a variety of reasons, such as to promote new and existing goods and services, to increase sales of the promoted goods or services, or to increase sales of merchants' other goods and services. Some consumers rely upon discounts as a way to reduce their costs.

Discount techniques include providing coupons and rebates to potential customers, but these techniques have several disadvantages, such as a historically small percentage of consumer participation and, in some cases, fraud. Because the participation level is so small, merchants are forced to canvas a large area in attempt to attract the correct demographic of potential customers for its goods or services. This is inefficient because most of the coupons or rebates, or the advertisements containing the coupons or rebates, end up with consumers that do not need or want the goods or services.

Additionally, fraud is an increasing problem in that coupons may be copied, or rebates may be used to obtain cash back for goods and services that a consumer, attempting to defraud the merchant, never actually purchased.

Coupons and rebates have historically only been distributed using direct mail, newspaper print, and magazines and have associated with them a low percentage of consumers of those actually receiving the coupons. Besides not being environmentally friendly, due to paper waste, the costs of using such mediums may outweigh any benefit received by the merchant. Additionally, and regardless of the mediums employed, there is typically very little reason for the consumer to pass along an advertisement or coupon to others, so that a merchant must advertise or market discounts individually to each potential customer.

There is currently no system or method to enable a merchant to efficiently convey discounts to consumers, while simultaneously providing an interactive experience to entice the consumers. Additionally, there is no system or method to enable the merchant to fully appreciate its customer base via social networks.

### SUMMARY

The following brief description is provided to indicate the nature of the subject matter disclosed herein. While certain aspects of the present inventive concept are described below, the summary is not intended to limit the scope of the present inventive concept. Embodiments of the present inventive concept provide a system configured to promote business goods and/or services to a user via an interface device of the user. The system provides means for offering a gift from the business to the user, allowing the user to transfer or share the gift with another user, and/or allowing the user to redeem the gift at the business.

The aforementioned may be achieved in one aspect of the present inventive concept by providing a method of giving a gift using a network. The method may include the steps of creating a gift token for a gift by accessing a first portal of the network using a unique identifier, the gift token including at least one metric defined during creation of the gift token, the gift token enabling redemption of the gift by a primary or secondary recipient, transmitting the gift token to the primary recipient using the network, the primary recipient in communication with the network via a second portal of the network, and/or providing a distribution option to the primary recipient to enable the recipient to distribute the gift token to the secondary recipient using the second portal of the network or a different network.

The method may further include the step of tracking one or more factors of a gift token using one or more technologies such as a code, a barcode, a quick response (QR) code, near-field communication (NFC), and/or the like. The one or more factors may be a number of times the gift token is scanned, redeemed, and/or submitted, a redemption rate of the primary recipient and/or the secondary recipient, and/or a number of times the gift token is forwarded and/or re-distributed. The at least one metric may include one or more of (i) a description of the gift, (ii) a maximum distribution limit operable to regulate distribution of the gift token by the primary recipient, and (iii) a period of time during which the gift token may be redeemed for the gift.

The description of the gift may include one or more of (i) contact data for a merchant offering the gift, (ii) a dollar value of the gift, and (iii) a geographic or virtual location for redeeming the gift token for the gift. The unique identifier may be log-in data specific to (i) a creator of the gift token and/or (ii) a merchant offering the gift. The unique identifier may be based on the gift represented by the gift token offered by a merchant. The second portal of the network and/or the different network may be accessible to the primary and secondary recipients via an application executable via a mobile device.

The mobile device may be one of (i) a personal computing device, (ii) a smart phone, (iii) a cellular phone, and (iv) a personal computer. The application may be (i) embodied as computer readable code on a non-transitory computer readable recording medium and executed by a computer processor, (ii) downloadable for use by the primary recipient or the secondary recipient via the network and/or the different network, and/or (iii) operable to provide 2-way communication between the primary recipient or the secondary recipient and a provider of the application. The network and/or the different network may include one or more of (i) a distribution list or social network associated with a creator of the gift token, (ii) a distribution list or social network associated with a merchant offering the gift, (iii) a distribution list or social network associated with the primary recipient or secondary recipient, (iv) a distribution list or social network associated with the provider of the application, and (v) the Internet.

The method may further include the step of providing the distribution option or another distribution option to the secondary recipient who has received the gift token from the primary recipient. The distribution option or the another distribution option may be operable to enable the secondary recipient to distribute the gift token to another secondary recipient using the network or the different network. The method may further include the step of tracking a course of the gift token from a point of creation, across the network and/or the different network, and to the primary recipient and/or the secondary recipient. The method may further include the step of transmitting data related to the course via the network to a merchant offering the gift.

The data related to the course may include one or more of (i) identification data of the primary recipient and/or the secondary recipient, (ii) preference data of the primary recipient and/or the secondary recipient, and (iii) relationship data of the primary recipient to the secondary recipient. The method may further include the step of adding the primary recipient and/or the secondary recipient to a distribution list of the merchant offering the gift when the primary recipient and/or the secondary recipient (i) redeems the gift token for the gift and/or (ii) recommends the gift to the secondary recipient or another secondary recipient. The method may further include the step of providing a code operable to enable redemption of the gift token. The code may be a two-dimensional barcode.

The aforementioned may be achieved in another aspect of the present inventive concept by providing a method of using a social network to distribute a gift. The method may include the steps of distributing the redeemable gift to a user of the social network via the social network, the user having a sub-network within the social network of a plurality of other users, and/or providing the user with a secondary-distribution option operable to permit the user to distribute the gift to one or more of the plurality of other users within the sub-network of the social network when the secondary-distribution option is executed by the user. The execution of the secondary-distribution option by the user may cause data related to one or more of the plurality of other users within the sub-network of the social network to be transmitted to one or more of (i) a creator of the gift, (ii) a merchant offering the gift, and/or (iii) an agent of the creator of or merchant offering the gift.

The redemption of the gift may cause data related to a redeemer of the gift to be transmitted to one or more of (i) the creator of the gift, (ii) the merchant offering the gift, and (iii) the agent of the merchant offering the gift. The gift may be one or more of a deal, a freebie, a coupon, a discount, a token redeemable for a discount, an offer for a free and/or discounted good and/or service, and a full or partial cash equivalent for a good and/or service at one or more merchants. The gift may include or be associated with a unique identifier. The unique identifier may be a barcode, a quick response (QR) code, an element operable to utilize near-field communication (NFC), and/or the like.

The aforementioned may be achieved in another aspect of the present inventive concept by providing a method of identifying consumers via a social network. The method may include the steps of providing a downloadable software application to a user across a network via a marketplace, the application providing two-way communication between the user and an agent, distributing a redeemable gift to the user via the application, and/or enabling the user to selectively identify at least one other user via a social network of the user to further distribute the gift. It is foreseen that if the user identifies the at least one other user, the method may include the step of causing instructions for redeeming the gift via the application to be transmitted to the at least one other user via the social network.

The instructions may include a link to a web page operable to enable download of the application by the at least one other user. The application may be executable to initiate communication with the social network. The application may be executable at least in part using the social network, e.g., the application may authenticate the user, e.g., an identity of the user, using the social network. The application may be operable to retrieve preexisting information associated with the user and/or the at least one other user via the social network. The information may be associated with the user and include preferences of the user and/or other users associated with the user, e.g., likes/dislikes of the user regarding products and/or services. The application may utilize a unique identifier for the user and/or at least one other user that is assigned by the social network so that accessing the social network enables simultaneous accessing of the application.

The aforementioned may be achieved in another aspect of the present inventive concept by providing a method of incentivizing and tracking patronage of a consumer by providing a range of potential gifts that can be activated or won by the consumer. The method may include the steps of providing a forum (i) with a plurality of selectable gifts to a merchant and/or (ii) for creating the plurality of selectable gifts by the merchant or an agent of the merchant, assigning a token and a redemption rate to a selected gift of the merchant, enabling activation of the token, transmitting the token and the redemption rate to a user via a network, and/or determining whether to offer the selected gift to the user when the user activates the selected gift based on the redemption rate. The method may further include the step of tracking one or more factors of the selected gift using one or more technologies such as a code, a barcode, a quick response (QR) code, near-field communication (NFC), and/or the like.

The one or more factors may be a number of times the gift token is scanned, redeemed, and/or submitted, the redemption rate of the primary recipient and/or the secondary recipient, and/or a number of times the gift token is forwarded and/or re-distributed. The gift token may be activated by the user via a peripheral computer device such as a computer mouse, keyboard or mobile device touchpad, and/or via photographing the selectable item and transmitting a photograph of the selectable item to the network. The redemption rate may be defined by the merchant as between 1 and 100 percent. The redemption rate may be a likelihood that the selected gift will be offered to the user based on a total number of activations of the selected gift. The selected gift may be transmitted to the user based on a geographic location of the user. The selected deal may be transmitted to the user based on a proximity of the user to a redemption location of the selected gift. The method may further include the step of adding the user to a sub-network of the network upon activation and/or redemption of the selected gift.

The aforementioned may be achieved in another aspect of the present inventive concept by providing a method of developing a sub-network of a network. The method may include the steps of establishing a sub-network associated with a merchant via a portal to a network accessible by the merchant, enabling transmission of a gift or a deal to a member of the sub-network from the merchant and/or to a non-member of the sub-network, and converting the non-member to another member of the sub-network when (i) the non-member redeems the deal or the gift offered by the merchant, (ii) the non-member or the member recommends or transmits the deal or the gift offered by the merchant or the merchant to another non-member, and/or (iii) the another non-member redeems or recommends the deal or the gift offered by the non-member or the member.

The method may further include the step of tracking one or more factors of the gift or the deal using one or more technologies such as a code, a barcode, a quick response (QR) code, near-field communication (NFC), and/or the like. The one or more factors may be a number of times the gift or the deal is scanned, redeemed, and/or submitted, a redemption rate of the primary recipient and/or the secondary recipient, and/or a number of times the gift or the deal is forwarded and/or re-distributed. The method may further include the step of converting the non-member to the another member of the sub-network when the non-member downloads an application associated with the gift or the deal. The method may further include the steps of collecting data associated with the member or the non-member upon receipt, redemption, and/or recommendation of the gift or the deal, and/or transmitting at least a portion of the collected data to the merchant. The collected data associated with the member or the non-member may include demographic data, identification data, gender data, age data, and a profile photograph.

The aforementioned may be achieved in one aspect of the present inventive concept by providing a method of incentivizing and tracking patronage of a consumer by providing a range of potential gifts that can be activated or won by the consumer. The method may include the steps of transmitting a token to the consumer representing a plurality of gifts from a merchant, providing a redemption rate for or odds of winning the one or more of the plurality of gifts, enabling activation of the one or more of the plurality of gifts using the token, revealing the one or more of the plurality of gifts upon activation of the token at a physical or virtual location of the merchant, and/or determining whether to offer the selected gift to the user when the user activates the selected gift based on the redemption rate.

The step including the activation may further include the step of scanning a unique identifier of the token and/or otherwise transmitting data related to the unique identifier to a database for determining whether to offer one or more of the plurality of gifts from the merchant to the consumer. The redemption rate of the one or more of the plurality of gifts may be variable across a linear spectrum with each of the one or more of the plurality of gifts having a differing likelihood of redemption relative to the other based on a linear placement of each of the one or more of the plurality of gifts on the spectrum. The differing likelihood of redemption may increase when traveling linearly in a single direction along the spectrum.

At least a portion of the present general inventive concept may be embodied in a computer readable medium and configured to be executed on one or more computing devices such as a computer, a PDA, a cellphone, a laptop, a computer, a desktop, a gaining console, a television gaming console, a handheld gaming console, a wireless gaining console, am LCD, an iPad, an iPhone, a smart phone, a television, or some other type of computing device.

While the present inventive concept has been described in connection with certain preferred embodiments, other embodiments would be understood by one of ordinary skill in the art and are encompassed herein.

### BRIEF DESCRIPTION OF THE FIGURES

The invention and the following detailed descriptions of certain embodiments thereof may be understood by reference to the following figures:

FIG. 1 is a diagram illustrating a communication network in accordance with the exemplary embodiment of the present inventive concept;

FIG. 2 is a flow chart illustrating a method of gifting from a merchant using the network illustrated in FIG. 1 in accordance with an exemplary embodiment of the present inventive concept;

FIG. 3 is a screenshot illustrating a gift received by a user from a merchant using the network illustrated in FIG. 1 in accordance with an exemplary embodiment of the present inventive concept;

FIG. 4 is a screenshot of an embodiment of a screen display for a merchant-access portal of the network in accordance with the exemplary embodiment of the present inventive concept;

FIG. 5 is a screenshot of a display with an interactive object displayed thereon in accordance with the exemplary embodiment of the present inventive concept;

FIG. 6 is another screenshot of an embodiment of a screen display for a merchant portal in accordance with various embodiments of the present inventive concept;

FIG. 7 is a flow chart illustrating a method of redeeming a gift from the merchant using the network illustrated in FIG. 1 in accordance with the exemplary embodiment of the present inventive concept;

FIG. 8 is a screenshot of an embodiment of a screen display for a user device depicting a digital scratch card in accordance with the exemplary embodiment of the present inventive concept; and

FIG. 9 is a flow chart illustrating another method of redeeming a gift from the merchant using the network illustrated in FIG. 1 in accordance with the exemplary embodiment of the present inventive concept.

The drawing figures do not limit the present inventive concept to the specific embodiments disclosed and described herein. The drawings are not necessarily to scale, emphasis instead being placed upon clearly illustrating the principles of the present inventive concept.

### DETAILED DESCRIPTION

The following detailed description of the present inventive concept references the accompanying drawings that illustrate specific embodiments in which the present inventive concept can be practiced. The embodiments are intended to describe aspects of the present inventive concept in sufficient detail to enable those skilled in the art to practice the present inventive concept. Other embodiments can be utilized and changes can be made without departing from the scope of the present inventive concept. The following detailed description is, therefore, not to be taken in a limiting sense. The scope of the present inventive concept is defined only by the appended claims, along with the full scope of equivalents to which such claims are entitled.

In this description, references to “exemplary embodiment,” “one embodiment,” “an embodiment,” or “embodiments” mean that the feature or features being referred to are included in at least one embodiment of the technology. Separate references to “exemplary embodiment,” “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

The terms “a” or “an,” as used herein, are defined as one or more than one. The term “another,” as used herein, is defined as at least a second or more. The terms “including” and/or “having” as used herein, are defined as comprising, i.e., open transition. The term “coupled” as used herein, is defined as indirectly or directly connected. The terms “business,” “company,” “agent,” “administrator,” and/or “merchant,” as used herein, are intended to be synonymous to each other irrespective of whether the use is singular or plural. The terms “consumer,” “customer,” “user,” “end user,” “another user,” “first user,” “second user,” “primary recipient,” and/or “secondary recipient,” as used herein, are intended to indicate one or more indivual users of the system and/or methods of the present inventive concept and may be generally synonymous to each other irrespective of whether the use is singular or plural.

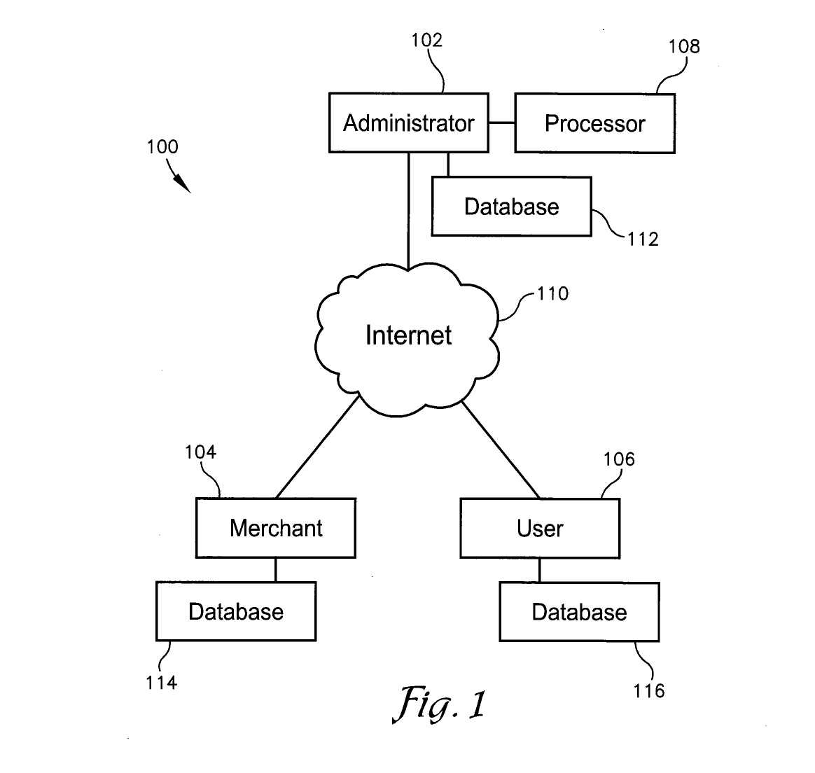

Turning to the drawings, and particularly FIG. 1, a system or communication network 100, in accordance with the exemplary embodiment of the present inventive concept, is illustrated. The communication network 100 generally includes an administrative-access portal 102, at least one merchant-access portal 104, and at least one user-access portal 106. The portals 102, 104, 106 are configured to independently communicate with each other via the Internet 110, e.g., wireless and/or wired networks. It is foreseen, however, that communication between the portals 102, 104, 106 is not limited to being through the Internet 110, but may be performed via any like communication means without deviating from the scope of the present inventive concept. The portals 102, 104, 106 may be accessed via a device such as, but not limited to, a computer, a PDA, a cellphone, a laptop, a computer, a desktop, a gaming console, a television gaming console, a handheld gaming console, a wireless gaming console, an LCD, an iPad, an iPhone, a smart phone, a television, or some other type of computing device, e.g., via a browser or smart-phone application configured to be controlled by the device.

The administrator-access portal 102 is configured for use by an administrator of the network 100. The administrator-access portal 102 may be, and is preferably, a controller configured to gather data obtained from the network 100 and processed via a processor 108. The data obtained from the network 100 and processed by the processor 108 may include, but is not limited to, information related to a customer demographic related to one or more customers having access to the network 100 via the at least one user-access portal 106. The customer demographic may further relate to one or more different businesses having access to the network 100 via the at least merchant-access portal 104. The customer demographic may be specified as a geographic area irrespective of specific business, e.g., a town, a city, a state, within ten miles of a business. The customer demographic may include a variety of information for each business and/or each customer of one or more businesses. The variety of information gathered for each customer may include user-specific information each customer makes independently and/or voluntarily available from the network 100 via one or more social networks of the user, e.g., those commonly known under the trademarks FACEBOOK® and LINKEDIN®, such as, but is not limited to, age, gender, ethnicity, marital status, employment title, status, and/or employer identity, family and/or relationships and/or connections, geographic location, e.g, zip code, income, and/or a photograph, e.g., a profile photograph of the user. Alternatively or in addition, the variety of user-specific information gathered for each customer may include information yielded by processing the variety of information via the processor 108 such as, but not limited to, when, where, and/or frequency with which a customer patronizes a business, average and/or frequency of monetary purchases by a customer, an identity of a business patronized by the customer, and/or a purchase made by the customer offered by a business.

The merchant-access portal 104 is configured for use by a business that offers goods and/or services to the public, e.g., a restaurant, a gym, a beauty salon, a sports or activity center, or the like. The merchant-access portal 104 may be, and is preferably, a large number of merchant-access portals 104 to accommodate use of the network 100 by millions of different businesses or merchants. The user-access portal 106 is configured for use by a consumer or end-user of the goods and/or the services offered to the public by the merchants. The user-access portal 106 may be, and is preferably, a large number of user-access portals 106 to accommodate use of the network 100 by millions of different users.

As illustrated in FIG. 1, the portals 102, 104, 106 are configured to independently communicate with each other independent from each other. Each of the portals 102, 104, 106 are each in independent communication with a database 112, 114, 116. The database 112, 114, 116 is configured to store methods, codes, program instructions, and/or other types of instructions capable of being executed by the device, e.g., a computing or processing device, and/or data received from any one or more of the portals 102, 104, 106. The database 112, 114, 116 may include one or more of a buffer, flip-flop, memory, hard disk, flash drive, optical drive, CD-ROM, DVD, ROM, cache, or the like.

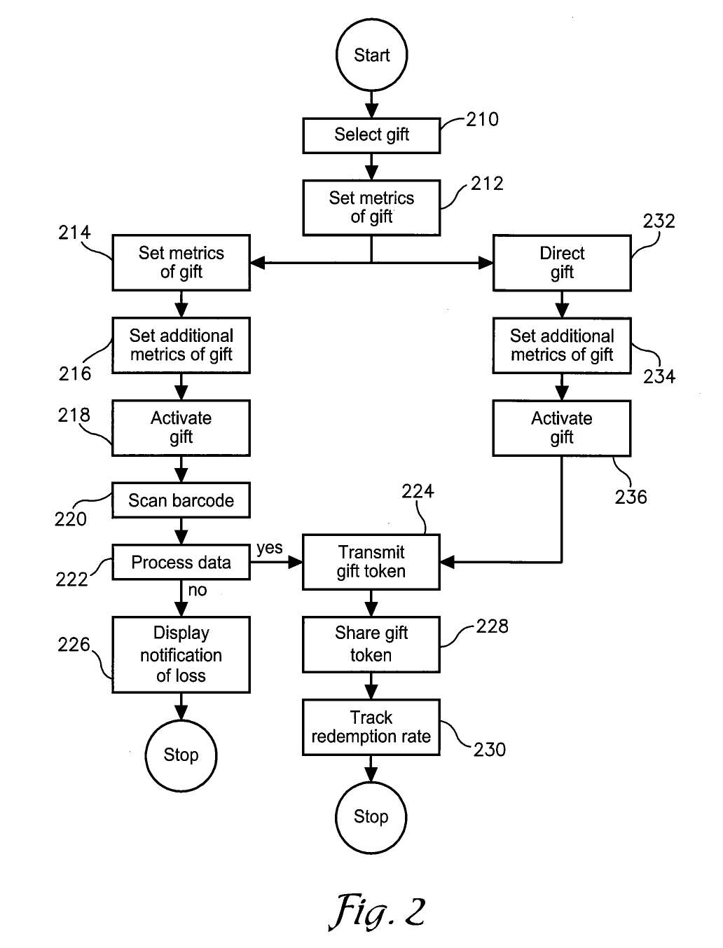

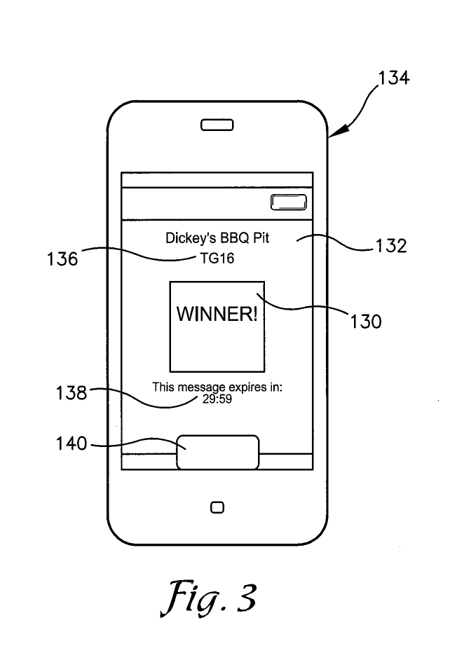

Turning to FIGS. 2-4, a flow chart is provided that illustrates a method of offering and/or transferring a gift or gift token 130 from a merchant using the merchant-access portal 104 of the network 100 illustrated in FIG. 1 in accordance with an exemplary embodiment of the present inventive concept. The gift token 130 represents one or more of a deal, a freebie, a coupon, a discount, a token redeemable for a discount from the merchant, an offer for a free and/or discounted good and/or service from the merchant, and a full or partial cash equivalent for a good and/or service from the merchant. The gift token 130 is configured to be displayed on a display 132 of a device 134 of the user with a unique identifier 136, details about or a description of the gift represented by the gift token 130, an anti-fraud component 138, and a distribution option or share function 140, as illustrated in FIG. 3.

In the exemplary embodiment, the device 134 is a smart phone. As previously discussed, however, the device 134 may be a personal computing device, a cellular phone, a personal computer and/or the like without deviating from the scope of the present inventive concept. The unique identifier 136 may be assigned to and/or different for each user to permit tracking by the merchant and/or the administrator regarding whether a specific user redeems the gift token 130, number of times the gift token 130 is scanned, redeemed, and/or submitted, a redemption rate, and/or a number of times the gift token 130 is forwarded or redistributed to other users after the merchant distributes the gift token 130 to the user. The unique identifier 136 enables redemption of the gift token 130 for the gift. The unique identifier 136 may be a code, a barcode, e.g., a two-dimensional barcode, and/or a plurality of characters, e.g., alphanumeric data. The unique identifier 136 may be specific to a creator of the gift token 130, and/or may be a name of the merchant offering the gift represented by the gift token 130. The unique identifier 136 may employ one or more technologies to allow tracking of the gift token 130, e.g., quick response (QR) code technology, near-field communication (NFC) technology, or the like.

The description of the gift represented by the gift token 130 may include one or more of contact data for the merchant offering the gift, a dollar value of the gift, and/or a geographic or virtual location where the user may redeem the gift token 130 to obtain the gift represented by the gift token 130. The anti-fraud component 138 may be a timer configured to count down from a predetermined amount of time, e.g., from a point when the gift token 130 was revealed by or transmitted to the user, during which the user may redeem the gift token 130, e.g., a thirty day countdown or thirty-minute countdown to indicate the user must redeem the gift token within such time, after which the gift token 130 expires and can no longer be redeemed. The share function 140 may be a button that, when actuated, provides the user with a secondary-distribution option, i.e., allows the user to send the gift token 130 to a sub-network of the user, e.g., secondary or other users in the network 100 and/or the social network of the user. For instance, actuation or selection of the share function 140 by the user may cause a message to be displayed to all of the other users within the network 100 and/or the social network of the user and/or allow the user to select individual ones of the other users within the network 100 and/or the social network of the user.

The merchant is able to gain access to the network 100 via the merchant-access portal 102 to create the gift token 130. As illustrated, the merchant selects the gift token 130, which represents the gift the merchant desires to offer the user, at step 210, from a variety Of gift tokens suggested by the administrator of the network 100, and/or created by the merchant. The gift token 130 may be stored in one or more of the databases 112, 114 for easy selection and saving by the merchant and monitoring by the merchant and administrator.

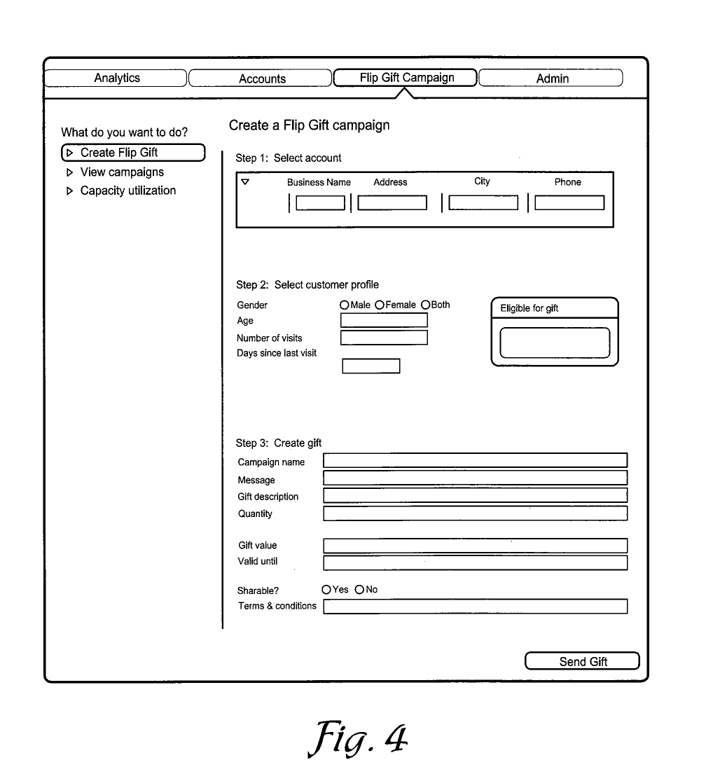

At step 212, as illustrated in FIG. 4, the merchant-access portal 102 allows the merchant to set one or more terms or metrics related to the gift to be offered to users via the gift token 130. The metrics may include one or more of a description of the gift represented by the gift token 130, e.g., twenty percent off a dessert or a free desert, a maximum distribution limit for the share function 140, e.g., three times (the user may forward the gift token 130 per the specified distribution limit/to three different users, and/or the gift token 130 may be forwarded per the specified distribution limit/three times, such as from the user 106 to one of the other users, then from the one of the other users to another one of the other users, and so on), a period of time during which the gift token may be redeemed for the gift for the anti-fraud component 138, e.g., 30 minutes or thirty days, and/or instructions regarding how to redeem the gift token 130 for the gift, e.g., a link to a website or web page of the merchant or of the adminstrator for downloading the application software. Additionally, the metrics may include selecting whether the gift token 130 is to be sent as: (1) an opportunity to win the gift; and/or (2) a direct offer for the gift, e.g., via the network 100.

At step 214, the gift token 130 may be selected by the merchant as the opportunity to win the gift. In this scenario, the merchant provides the user with the opportunity to win the gift token 130, with such an opportunity made available to the user via an interactive object such as a barcode 150 or the like configured to be scanned by the user, e.g., via the device 134 of the user. This scenario may be desirable to the merchant if, for example, the merchant desires to obtain new information from new users and/or that the user has a positive experience at the one or more locations of the merchant.

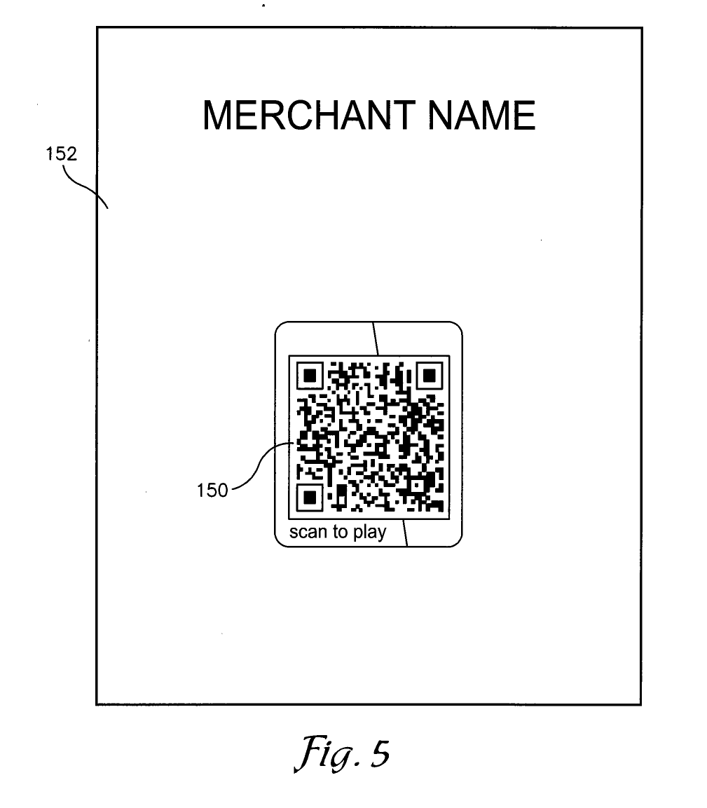

The barcode 150 may be displayed by the merchant via a sign 152, as illustrated in FIG. 5, e.g., posted at an entrance to the one or more locations of the merchant, on a menu of the merchant, e.g., a food menu, and/or at a virtual location of the merchant, e.g., on a website. In this manner, the user may scan the barcode displayed by the merchant, e.g., using a scanning function installed on the device 134.

The application software may be smart-phone application software made available to the user via the administrator for download via a marketplace, e.g., those made available under the marks APPLE® or ANDROID®. The application software may be embodied as computer readable code on a non-transitory computer readable recording medium and executed by a computer processor. The application software may be downloadable by the users via the network 100 and/or a different network, e.g., the Internet 110, stored in the user database 116, and/or operable to provide communication, e.g., 2-way communication, between the users, the administrator, e.g., the provider of the application, and/or the merchant. The application software may grant access to the user's social network, which typically already contains the user-specific information previously discussed. In this manner, the network 100 is configured to obtain, via the application software on the device 134, the user-specific information about the user.

At step 216, the merchant sets the metrics required to “win” the gift token 130, e.g., odds of winning or redemption rate, which enables the merchant to target a specific demographic of consumers using the user-specific information of each user previously discussed. For purposes herein, winning the gift token is intended to mean that the user who obtains the gift token 130, which process will be further described hereafter, is presented with an opportunity to redeem the gift token 130 for the gift represented by the gift token 130. In other words, to receive and redeem the gift token 130, the user must satisfy the metrics set by the merchant, which relate to the user-specific information of each user. If the user fails to redeem the gift token 130 at the merchant in view of the anti-fraud component 138, e.g., within the time period set by the merchant, the user is prevented from obtaining the gift from the merchant.

The metrics may be objective criteria determined by the merchant, e.g., one in one hundred users who scan the barcode 150 will win the gift token 130, subjective criteria determined by the merchant based on whether or not the user has already won the gift token 130 within a specified time period, e.g., the gift token 130 may not be won if the user has previously won the gift token 130 during the past month, subjective criteria determined by the merchant based on the user-specific information of the user previously discussed, e.g., the gift token 130 may only be won by female users who are between thirty and forty years of age, and/or subjective criteria subjective criteria based on proximity of the user to the merchant, e.g., the gift token 130 may be won by a user within a close proximity to the merchant, e.g., within a five-mile radius to the merchant.

At step 218, the gift token 130 is activated with one or more of the aforementioned metrics set. As an example, the above metrics with described objective and subjective criteria are required by the merchant. Thus, the user, in this scenario, will only receive the gift token 130 for redeeming the gift if the user (i) visits the one or more locations of the merchant, (ii) scans the barcode 150, (iii) is the one out of the one hundred users who have scanned the barcode 150, (iv) has not won the gift token 130 within the last thirty days, (v) is female, and (vi) is between thirty and forty years of age. Step 220 illustrates the point when the barcode 150 is scanned using the device 134 of the user. At step 220, the user-specific information related to the user, as previously discussed, is transmitted from the device 134 to the network 100 and stored in the database 112, 114. At step 222, the user-specific information is received at the administrative portal 102 via the network 100, processed via the processor 108, and stored in the database 112.

The processor 108 is configured to cause the gift token 130 to be transmitted to the user at step 224 if the metrics set by the merchant are completely satisfied. Alternatively, if the metrics set by the merchant are not satisfied, the user is notified at step 226 that the user has not won the gift token 130. Given that the user-specific information has been received from the user and is stored in the database 112, 114, the gift token 130 may be transmitted to the user at another time via the direct offer, which is described hereafter.

At step 228, the user may share the gift token 130 via the sharing function 140, if the merchant has selected the metric allowing the user to the share the gift token 130. As previously discussed, operation of the share function 140 is set by the merchant to allow the user to forward the gift token 130 any number of times per the specified distribution limit, e.g., zero-ten. In this manner, the user is able to recommend the gift and/or the merchant to another user. The share function 140 may be a button to allow the user to send the gift token 130 to other users in the network 100 and/or the social network of the user, which may be monitored by the merchant using the network 100. For instance, selection of the share function 140 by the user may cause a message to be displayed to all of the other users within the network 100 and/or the social network of the user and/or allow the user to select individual ones of the other users within the network 100, the social network of the user, and/or other distribution list. The network 100 and/or the social network of the user allow the merchant to monitor or track a course of the gift token 130, e.g., via a reporting function when the user selects or “tags” the gift token 130, i.e., the merchant, and/or when the user redeems the gift token 130 for the gift using the unique identifier 136. Using the network 100 and/or the social network of the user, the merchant is able to obtain identification of the one or more users, deduce preference data, e.g., like/dislike data, by monitoring which one or more of the one or more users redeem the gift token 130 for the gift, and/or relationship or connection data between the one or more users. In this manner, the merchant is able to track a course of the gift token 130 between different users while obtaining data that may be valuable to the merchant, e.g., allow the merchant to add the one or more users the a distribution list stored in the database 114 of the merchant, thereby converting non-member to members of a sub-network of the merchant.

At step 230, rate of redemption is tracked by determining whether the user has redeemed the gift token 130 for the gift. To redeem the gift token 130 for the gift, the user must notify the merchant, e.g., a cashier of the merchant at a point of sale, that the user has and would like to redeem the gift token 130. The user may display the gift token 130 on the device 134 so that the merchant may view the unique identifier 136. Alternatively, if the user is visiting a virtual location of the merchant, e.g., a website of the merchant, the user may input the unique identifier 136 on the website at checkout to receive the gift from the merchant.

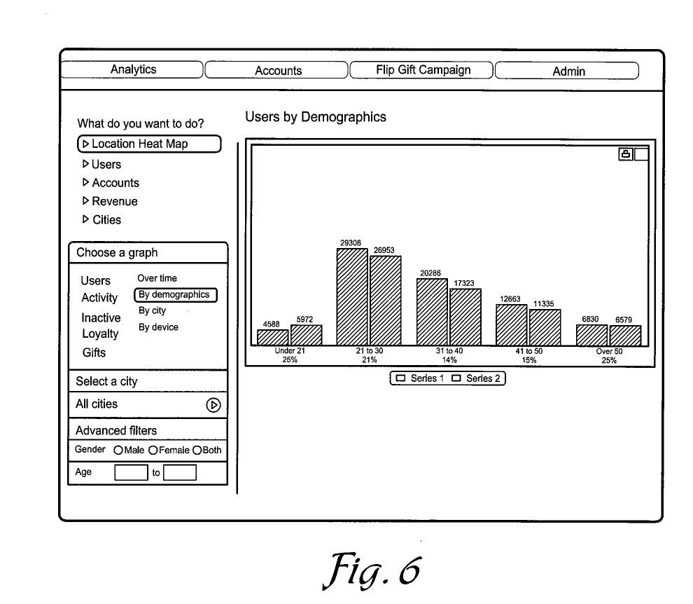

If the unique identifier 136 is set by the merchant to be different for each different user, then the merchant knows the redemption rate per the user. If the unique identifier 136 is set by the merchant to be different for each different gift, then the merchant generally knows the redemption rate per the gift token 130. Thus, the unique identifier 136 may be set based on level or degree of information desired by the merchant. In this manner, the merchant is provided with valuable statistical and demographic data regarding its business and customer base, e.g., is able to determine degree of success of the gift token 130 and likes/dislikes of the user using the present inventive concept. An example screen shot of such data provided via the merchant-access portal 104 is provided via FIG. 6.

Rather than selecting the opportunity to win the gift, the gift token 130 may be selected by the merchant as the direct offer for the gift, at step 232. In this scenario, the merchant sends the gift token 130 directly to the user so that the user may simply visit the one or more locations of the merchant to redeem the gift token 130 for the gift represented by the gift token 130. This scenario may be desirable to the merchant if, for example, the merchant desires to invite the user back to the one or more locations of the merchant because the user has not visited the one or more locations recently, e.g., within the last thirty days.

In step 234, the merchant sets the metrics required to receive the gift token 130. Step 234 is similar to step 216, except that the merchant does not set an odds of winning because, in this scenario, the gift token 130 is simply transmitted to the user. The metrics, however, still enable the merchant to target a specific demographic of consumers using the user-specific information of each user previously discussed. To receive and redeem the gift token 130, the user must satisfy the metrics set by the merchant, which relate to the user-specific information of each user. If the user fails to redeem the gift token 130 at the merchant in view of the anti-fraud component 138, e.g., within the time period set by the merchant, the user is prevented from obtaining the gift from the merchant.

The metrics may be subjective criteria determined by the merchant based on whether or not the user has scanned the barcode 150 and/or won the gift token 130 within a specified time period, e.g., the gift token 130 may not be transmitted to the user if the user has scanned the barcode 150 and/or won the gift token, as indicated by information in the database 112, 114, during the past month, subjective criteria determined by the merchant based on the user-specific information of the user previously discussed, e.g., the gift token 130 may only be sent to female users who are between thirty and forty years of age, and/or subjective criteria subjective criteria based on proximity of the user to the merchant, e.g., the gift token 130 may be only be sent to a user within a close proximity to the merchant, e.g., within a five-mile radius to the merchant.

At step 236, the gift token 130 is activated with one or more of the aforementioned metrics set. As an example, the above metrics with described subjective criteria are required by the merchant. Thus, the user, in this scenario, will only receive the gift token 130 for redeeming the gift if the user (i) has not won the gift token 130 within the last thirty days, (ii) is female, and (iii) is between thirty and forty years of age.

The scenario then proceeds as previously discussed. At step 224, the processor 108 is configured to cause the gift token 130 to be transmitted to the user at step 224 if the metrics set by the merchant are completely satisfied. At step 228, the user may share the gift token 130 via the sharing function 140, if the merchant has selected the metric allowing the user to share the gift token 130. At step 230, rate of redemption is tracked by determining whether the user has redeemed the gift token 130 for the gift.

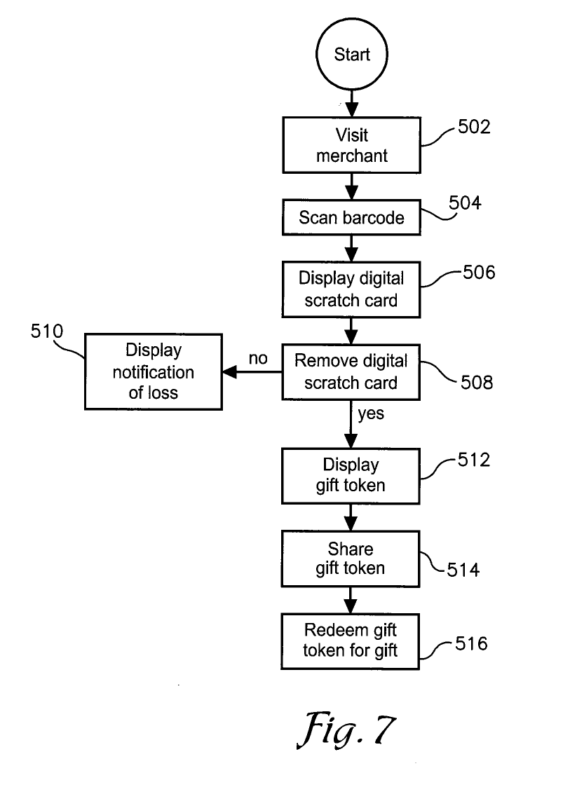

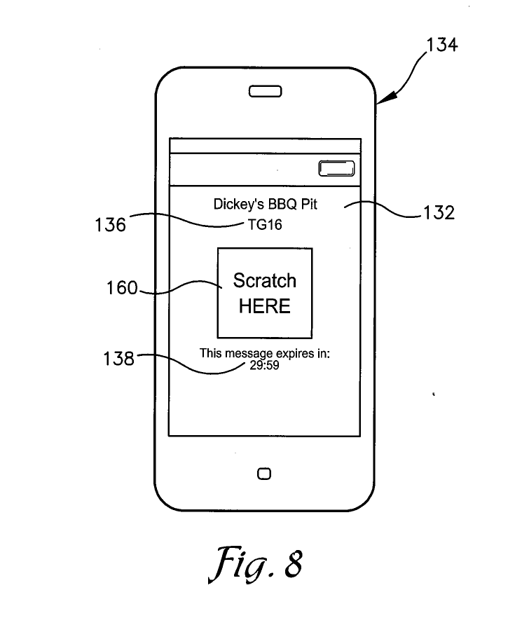

From the user's perspective in the opportunity to win the gift scenario, as illustrated in FIG. 7, the user is provided with the opportunity to win the gift from the merchant when the user visits the one or more locations of the merchant, at step 502. At step 504, the user scans the barcode 150 displayed on the sign 152 by the merchant using the application software on the device 134. Upon scanning the barcode 150, the user-specific information, as previously discussed, is transmitted through the network 100. At step 506, a digital scratch card 160 is displayed on the display 132 of the device 134, upon scanning of the barcode 150, as illustrated in FIG. 8. The digital scratch card 160 is configured to be scratched off, wiped off, or otherwise disappears from the display 134 when the user touches a portion of the display 132 that corresponds to a location of the digital scratch card 160 on the display 134. As the digital scratch card 160 is being removed from the display 132 by the user and when at least a portion of the digital scratch card 160 is no longer depicted by the display 132, at step 508, a message is revealed to indicate to the user whether or not the use has won the gift. If the user has not won the gift, a message is displayed to notify the user that the user has not won the gift token 130, at step 510. If the user has won the gift, the gift token 130 is displayed, in step 512, as illustrated in FIG. 3.

At step 514, if the merchant has selected the metric allowing the user to share the gift token 130, the user may share the gift token 130 via the sharing function 140. As previously discussed, operation of the share function 140 is set by the merchant to allow the user to forward the gift token 130 any number of times per the specified distribution limit to one or more secondary recipients or members, e.g., other users, with the network 100, the social network of the user, and/or other distribution list.

At step 516, the user redeems the gift token 130 to receive the gift. As previously discussed, to redeem the gift token 130 for the gift, the user must notify the merchant, e.g., the cashier of the merchant at a point of sale, that the user has and would like to redeem the gift token 130. The user may display the gift token 130 on the device 134 so that the merchant may view the unique identifier 136. Alternatively, if the user is visiting a virtual location of the merchant, e.g., a website of the merchant, the user may input the unique identifier 136 on the website at checkout to receive the gift from the merchant. In this manner, the user is able to win a gift from the merchant.

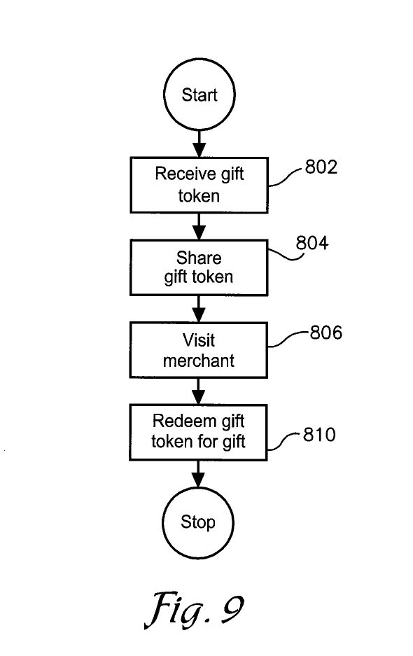

From the user's perspective in the direct offer for the gift scenario, as illustrated in FIG. 9, the user receives the gift token 130 representing the gift directly from the merchant, at step 802. Alternatively, the user may receive the gift token 130 from another user via the sharing function 140. At step 804, if the merchant has selected the metric allowing the user to share the gift token 130, the user may share the gift token 130 via the sharing function 140. As previously discussed, operation of the share function 140 is set by the merchant to allow the user to forward the gift token 130 any number of times per the specified distribution limit to one or more members, e.g., other users, with the network 100, the social network of the user, and/or other distribution list.

At step 806, the user visits the one or more locations of the merchant, e.g., a physical or virtual location such as a website of the merchant, to redeem the gift token 130 for the gift. At step 810, the user redeems the gift token 130 to receive the gift from the merchant. As previously discussed, to redeem the gift token 130 for the gift, the user must notify the merchant, e.g., the cashier of the merchant at a point of sale, that the user has and would like to redeem the gift token 130. The user may display the gift token 130 on the device 134 so that the merchant may view the unique identifier 136. Alternatively, if the user is visiting a virtual location of the merchant, e.g., a website of the merchant, the user may input the unique identifier 136 on the website at checkout to receive the gift from the merchant. In this manner, the user is able to receive a direct gift from the merchant.

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network 100. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The system, methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music users and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes or functions may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

Having now described the features, discoveries and principles of the general inventive concept, the manner in which the general inventive concept is constructed and used, the characteristics of the construction, and advantageous, new and useful results obtained; the new and useful structures, devices, tools, elements, arrangements, parts and combinations, are set forth in the appended claims.

It is also to be understood that the following claims are intended to cover all of the generic and specific features of the general inventive concept herein described, and all statements of the scope of the general inventive concept which, as a matter of language, might be said to fall therebetween.

What is claimed:

1. A method of giving a gift using a network, the method comprising the steps of:
creating a gift token for a gift by accessing a first portal of the network using a unique identifier, the gift token including at least one metric defined during creation of the gift token, the gift token enabling redemption of the gift by a primary recipient;
transmitting the gift token to the primary recipient using the network, the primary recipient in communication with the network via a second portal of the network; and
providing a distribution option to the primary recipient to enable the recipient to distribute the gift token to a secondary recipient using the second portal of the network or a different network.

2. The method of claim 1, and
tracking one or more factors of a gift token using a barcode, a quick response (QR) code, or near-field communication (NFC).

3. The method of claim 2,
wherein the one or more factors is at least one of (i) a number of times the gift token is scanned, redeemed, or submitted, (ii) a redemption rate of the primary recipient or the secondary recipient, and (iii) a number of times the gift token is forwarded.

4. The method of claim 1,
wherein the at least one metric includes one or more of (i) a description of the gift, (ii) a maximum distribution limit operable to regulate distribution of the gift token by the primary recipient, and (iii) a period of time during which the gift token may be redeemed for the gift.

5. The method of claim 4,
wherein the description of the gift includes one or more of (i) a contact data for a merchant offering the gift, (ii) a dollar value of the gift, and (iii) a geographic or virtual location for redeeming the gift token for the gift.

6. The method of claim 1,
wherein the unique identifier is based on the gift represented by the gift token offered by a merchant.

7. The method of claim 1,
wherein the second portal of the network and/or the different network is accessible to the primary and secondary recipients via an application executable via a mobile device.

8. The method of claim 7,
wherein the mobile device is one of (i) a personal computing device, (ii) a smart phone, (iii) a cellular phone, and (iv) a personal computer.

9. The method of claim 1, and
providing the distribution option to the secondary recipient who has received the gift token from the primary recipient, the distribution option operable to enable the secondary recipient to distribute the gift token to another secondary recipient using the network or the different network.

10. The method of claim 1, and
tracking a course of the gift token from a point of creation, across the network and/or the different network, and to the primary recipient and/or the secondary recipient; and
transmitting data related to the course via the network to a merchant offering the gift.

11. The method of claim 10,
wherein the data related to the course includes one or more of (i) identification data of the primary recipient and/or the secondary recipient, (ii) preference data of the primary recipient and/or the secondary recipient, and (iii) relationship data of the primary recipient to the secondary recipient.

12. The method of claim 1, and
adding the primary recipient and/or the secondary recipient to a distribution list of a merchant offering the gift when the primary recipient and/or the secondary recipient (i) redeems the gift token for the gift and/or (ii) recommends the gift to the secondary recipient or another secondary recipient.

13. A method of using a social network to distribute a gift, the method comprising:
distributing a redeemable gift to a user of the social network via the social network, the user having a sub-network within the social network of a plurality of other users; and
providing the user with a secondary-distribution option operable to permit the user to distribute the gift to one or more of the plurality of other users within the sub-network of the social network when the secondary-distribution option is executed by the user.

14. The method of claim 13,
wherein execution of the secondary-distribution option by the user causes data related to the one or more of the plurality of other users within the sub-network of the social network to be transmitted to one or more of (i) a creator of the gift, (ii) a merchant offering the gift, and (iii) an agent of the creator or merchant offering the gift.

15. The method of claim 13,
wherein redemption of the gift causes data related to a redeemer of the gift to be transmitted to one or more of (i) a creator of the gift, (ii) a merchant offering the gift, and (iii) an agent of the merchant offering the gift.

16. The method of claim 13,
wherein the gift is one or more of a deal, a freebie, a coupon, a discount, a token redeemable for a discount, an offer for a free and/or discounted good and/or service, and a full or partial cash equivalent for a good and/or service at one or more merchants.

17. The method of claim 16,
wherein the gift is associated with a unique identifier.

18. The method of claim 17,
wherein the unique identifier is a barcode, a quick response (QR) code, or an element operable to utilize near-field communication (NFC).

19. A method of identifying consumers via a social network, the method comprising:
providing a downloadable software application to a user across a network via a marketplace, the application providing two-way communication between the user and an agent;
distributing a redeemable gift to the user via the application; and
enabling the user to selectively identify at least one other user via a social network of the user to further distribute the gift,
wherein if the user identifies the at least one other user, then instructions for redeeming the gift via the application is transmitted to the at least one other user via the social network.

20. The method of claim 19,
wherein the instructions includes a link to a web page operable to enable download of the application by the at least one other user.

21. The method of claim 19,
wherein the application is operable to retrieve preexisting information associated with the user or the at least one other user via the social network.

22. A method of incentivizing and tracking patronage of a consumer by providing a range of potential gifts that can be received by the consumer, the method comprising:
providing a forum with a plurality of selectable gifts to a merchant;
assigning a token and a redemption rate to a selected gift of the merchant;
enabling activation of the token;
transmitting the token and the redemption rate to a user via a network; and
determining whether to offer the selected gift to the user when the user activates the selected gift based on the redemption rate.

23. The method of claim 22, and
tracking one or more factors of the selected gift using a barcode, a quick response (QR) code, or near-field communication (NFC).

24. The method of claim 22,
wherein the one or more factors is a number of times the gift token is scanned, redeemed, and/or submitted, a redemption rate of the primary recipient and/or the secondary recipient, and/or a number of times the gift token is forwarded and/or re-distributed.

25. The method of claim 22,
wherein the token is activated by the user via (i) a computer mouse, (ii) an appendage of the user, and/or (iii) photographing the selectable item and transmitting a photograph of the selectable item to the network.

26. The method of claim 22,
wherein the redemption rate is defined by the merchant as between 1 and 100 percent.

27. The method of claim 22,
wherein the redemption rate is a likelihood that the selected gift will be offered to the user based on a total number of activations of the selected gift.

28. The method of claim 22,
wherein the selected deal is transmitted to the user based on a proximity of the user to a redemption location of the selected gift.

29. A method of developing a sub-network of a network, the method comprising:
establishing a sub-network associated with a merchant via a portal to a network accessible by the merchant;
enabling transmission of a gift to a member of the sub-network from the merchant and/or to a non-member of the sub-network; and
converting the non-member to the member of the sub-network when (i) the non-member redeems the deal or the gift offered by the merchant, (ii) the non-member or the member recommends or transmits the deal or the gift offered by the merchant or the merchant to another non-member, and/or (iii) the another non-member redeems or recommends the deal or the gift offered by the non-member or the member.

30. The method of claim 29, and
tracking one or more factors of the gift using a barcode, a quick response (QR) code, or near-field communication (NFC).

31. The method of claim 29,
wherein the one or more factors is a number of times the gift is scanned, redeemed, and/or submitted, a redemption rate of the primary recipient and/or the secondary recipient, and/or a number of times the gift is forwarded and/or re-distributed.

32. The method of claim 29, and
converting the non-member to the member of the sub-network when the non-member downloads an application associated with the gift.

33. The method of claim 29, and
collecting data associated with the member or the non-member upon receipt, redemption, and recommendation of the gift, and
transmitting at least a portion of the collected data to the merchant.

34. The method of claim 33,
wherein the collected data associated with the member or the non-member includes demographic data, identification data, gender data, age data, and a profile photograph.

35. A method of incentivizing and tracking patronage of a consumer by providing a range of potential gifts that can be activated or won by the consumer, the method comprising:
transmitting a token to the consumer representing a plurality of gifts from a merchant;
providing a redemption rate for odds of winning the one or more of the plurality of gifts from the merchant to the consumer;
enabling activation of the one or more of the plurality of gifts from the merchant by the consumer using the token;
revealing the one or more of the plurality of gifts from the merchant to the consumer upon activation of the token at a physical or virtual location of the merchant; and
determining whether to offer the selected gift to the user when the user activates the selected gift based on the redemption rate.

36. The method of claim 35,
wherein activation includes scanning a unique identifier of the token and transmitting data related to the unique identifier to a database to determine whether to offer one or more of the plurality of gifts from the merchant to the consumer.
